(19) United States
(12) Patent Application Publication
(10) Pub. No.: US 2020/0389600 A1
(43) Pub. Date: Dec. 10, 2020

(54) ENVIRONMENT-DRIVEN USER FEEDBACK FOR IMAGE CAPTURE

(71) Applicant: Capital One Services, LLC, McLean, VA (US)

(72) Inventors: Nicholas CAPURSO, McLean, VA (US); Jason PRIBBLE, McLean, VA (US); Daniel Alan JARVIS, McLean, VA (US)

(73) Assignee: Capital One Services, LLC, McLean, VA (US)

(21) Appl. No.: 16/435,114

(22) Filed: Jun. 7, 2019

(51) Int. Cl. H04N 5/232; G06T 7/73; G06N 20/20

(52) U.S. Cl. CPC H04N 5/232941; H04N 5/232945; H04N 5/23218; G06N 20/20; G06T 7/73

(57) ABSTRACT

Disclosed herein are system, method, and computer program product embodiments for generating a recommendation displayed on a graphical user interface (GUI) for positioning a camera or object based on environmental information. In an embodiment, a mobile device may monitor information related to an environment surrounding the mobile device. This information may be retrieved from different sensors of the mobile device, such as a camera, clock, positioning sensor, accelerometer, microphone, and/or communication interface. Using this information, a neural network is able determine a predicted camera environment and generate a recommendation. The mobile device may display the recommendation on a graphical user interface (GUI) to recommend a camera position or an object position. This recommendation may aid in capturing an image of the object and aid in enhancing the image quality.

### BACKGROUND

Some entities, such as financial institutions, banks, and the like, permit users to capture an image of an identification document (e.g., government-issued identification (ID) cards and the like) using a user device, and submit the images to a backend-platform for validating the identification document. For example, the backend-platform may analyze the identification document to determine if the identification document is valid, extract text from the identification document, or the like. However, some backend-platforms may reject an uploaded image for not meeting image quality standards. This process may also occur when an image of a check is captured.

A user may submit a low-quality image based on various environments surrounding the camera. For example, a user may capture a dark image outside in the night time. Similarly, the user may attempt to capture an image in a vehicle causing the camera to vibrate. These different environments may lead to different issues affecting image quality. Poor image quality may lead to a rejection of the submitted identification and wasteful image processing. Further, multiple image rejections may cause a user to become frustrated with the image capture process.

While techniques have been proposed to correct glare, contrast, or brightness in an image, these techniques do not provide an approach applicable to different environments. Further, these techniques do not address other environmental issues affecting image quality or provide feedback tailored to the user's surroundings.

### BRIEF SUMMARY

Disclosed herein are system, apparatus, device, method and/or computer program product embodiments, and/or combinations and sub-combinations thereof, for generating a recommendation displayed on a graphical user interface (GUI) for positioning a camera or an object based on environmental information.

In an embodiment, a mobile device may monitor information related to an environment surrounding the mobile device. This information may be retrieved from different sensors of the mobile device, such as a camera, clock, positioning sensor, accelerometer, microphone, and/or communication interface. Using this information, a neural network is able determine a predicted camera environment and generate a recommendation. The mobile device may display the recommendation on a graphical user interface (GUI) to recommend a camera position or an object position. This recommendation may aid in capturing an image of the object and aid in enhancing the image quality.

In some embodiments, a computer-implemented method for generating a recommendation for display on a GUI may include receiving a command to access a camera on a mobile device. In response to receiving the command, a sensor of the mobile device may be detected and information from the sensor related to an environment of the mobile device may be recorded. A predicted camera environment describing the current surroundings where the mobile device is located may be determined based on the recorded information. A recommendation for display on a GUI may be generated based on the predicted camera environment. The recommendation may propose a way to better position the camera for capturing an image.

In some embodiments, a system for generating a recommendation for display on a GUI may comprise a memory device (including software and/or hardware) and at least one processor coupled to the memory device. The processor may be configured to receive a command to access a camera on a mobile device. In response to receiving the command, the processor may detect a sensor of the mobile device and record information from the sensor related to an environment of the mobile device. The processor may determine a predicted camera environment describing the current surroundings where the mobile device is located based on the recorded information. The processor may generate a recommendation for display on a GUI may be generated based on the predicted camera environment. The recommendation may propose a way to better position an object intended to be captured by the camera.

In some embodiments, a non-transitory computer-readable device is disclosed, the non-transitory computer-readable device may have instructions stored thereon that, when executed by at least one computing device, may cause the at least one computing device to perform operations including receiving a command to access a camera on a mobile device and in response to the receiving the command, detecting a sensor of the mobile device. Information from the sensor related to an environment of the mobile device may be recorded. Test image data from the camera related to the environment of the mobile device may also be recorded. A predicted camera environment describing the current surroundings where the mobile device is located may be determined based on the recorded information and the test image data. A recommendation for display on a GUI may be generated based on the predicted camera environment. The recommendation may propose a way to better position the camera for capturing an image.

### BRIEF DESCRIPTION OF THE DRAWINGS

The accompanying drawings are incorporated herein and form a part of the specification.

FIG. 1A depicts a block diagram of a mobile device, according to some embodiments.

FIG. 1B depicts a block diagram of components of a mobile device, according to some embodiments.

FIG. 2A depicts a flow diagram illustrating a flow for generating a recommendation on a graphical user interface (GUI) for positioning a camera, according to some embodiments.

FIG. 2B depicts a flow diagram illustrating a flow for identifying an agitation state, according to some embodiments.

FIG. 3A depicts a block diagram of GUI displaying a textual recommendation related to the object for image capture, according to some embodiments.

FIG. 3B depicts a block diagram of GUI displaying a textual recommendation related to the camera position for image capture, according to some embodiments.

FIG. 4 depicts a block diagram of GUI displaying an image recommendation, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for generating a recommendation for display on a graphical user interface (GUI) that proposes a way to better position a camera or an object relative to one another for image capture.

In an embodiment, a mobile device may include a camera and/or other sensors configured to capture data to determine an environment describing the surroundings of the mobile device. Using this determined environment, the mobile device may generate a recommendation for positioning the camera and/or the object for image capture. The object may be, for example, a card or paper. In an embodiment, the object may be a government identification, such as a driver's license, passport, or other identification item or document. In an embodiment, the object may be a document such as a check or a deposit slip. Using the environmental information, the mobile device may generate and display a recommendation for positioning the camera and/or the object to aid in capturing a higher quality image.

The surrounding environment for a mobile device may be described by factors affecting image quality. Environmental factors may include, for example, whether it is daytime or nighttime, the weather, the geographic location, whether the mobile device is located indoors or outdoors, a particular room in a location, whether the mobile device is in a vehicle, whether the vehicle is moving, the type of vehicle, and/or other factors describing the environment surrounding the mobile device. To predict or categorize this environment, a camera and/or another sensor of the mobile device may detect several elements of the environment. For example, sensor data may be received and processed to detect a predicted camera environment. Sensor data may include a location within an environment where the user has placed the object, background image data behind the object, whether the mobile device is vibrating, the type or quality of a wireless communication signal, audio information, and/or other information gathered from the mobile device. Using this information, the mobile device may apply machine learning and/or decision tree processing to determine a predicted camera environment from the received image and/or sensor data. The mobile device may then generate a recommendation corresponding to the predicted camera environment.

For example, a clock sensor or other time sensor may sense that the time of day is the night time. Another sensor may include an ambient light sensor or a camera. These sensors may sense darkness. A global position system (GPS) or other sensor may also indicate that the mobile device is located outside. Based on this collected environment information, the predicted camera environment may be outside and during the night. One or more of these sources of information may be used. In an embodiment, multiple sources of information provide redundancy to confirm a particular predicted camera environment.

Based on the determined predicted camera environment of being outside and/or night time, the mobile device may generate and display a recommendation for positioning the camera and/or the object. For example, in the night time, light may be scarce. In response to detecting that the mobile device is located outdoors, the recommendation may be a suggestion to the user to capture the image indoors. For example, the recommendation may be a textual message displayed on a GUI stating “Please go inside to capture the image.” The recommendation may be implemented using machine learning, a neural network, and/or a decision tree used to determine the recommendation based on the predicted camera environment.

In an embodiment, the mobile device may detect that a user is attempting to capture an image in a vehicle. For example, global positioning system data may indicate that the user is traveling on a road or highway. In an embodiment, the vehicle may be stationary and images captured from the camera may include identifying information indicating that the user is located within a car. For example, if the user is attempting to capture an image of an object, the image may include a steering wheel, radio, or dashboard in the peripheral areas of the image. Using image classification techniques, the mobile device may classify these objects to aid in determining the predicted camera environment as being within a vehicle. For example, the image classification may indicate that the user is a passenger of a car or a bus. In an embodiment, a wireless connection such as a Bluetooth connection to a car's infotainment system may also indicate that the mobile device is located within a car. Motion sensors may also detect that a user has entered a vehicle based on a detected pattern of mobile device movement.

Based on this determination, the recommendation may relate to stability and/or object positioning for a clearer image. For example, if the user is attempting to place the object on their pant leg, the recommendation may be to place the object on a flat surface of the vehicle such as the dashboard or the seat.

In an embodiment, based on additional image information, the mobile device may determine that the user is attempting to capture an image while the object is resting on an unstable location such as the lap of a user. The mobile device may identify clothing material, color, or texture information related to the background of the object and determine that the user is resting the object in an unstable location. With the context of the environment being a vehicle, the mobile device may recommend the more stable location within the vehicle based on the training of the machine learning neural network and/or decision tree.

In response to detecting this environment, the mobile device may generate a recommendation using a textual, image, icon, video, and/or animated image display on a GUI. For example, if the recommendation is to place the object on the dashboard, an animated image may depict an image of a dashboard with an animated arrow pointing to the arrow.

In an embodiment, the mobile device may identify peripheral image information to indicate that a user is attempting to capture an image of the object while holding the object in his or her hand. The mobile device may identify this environmental position as well as other factors such as daytime or nighttime. Similarly, the position may be considered with other factors such as being indoors, outdoors, or within a vehicle. In response to this detection, the mobile device may use a hierarchical structure such as a decision tree or may use a machine learning technique such as a neural network to provide a recommendation. In this manner, the recommendation may consider multiple factors in generating a recommendation.

The recommendation may also differ based on other available items in the predicted camera environment. For example, the mobile device may determine that it is located indoors based on a GPS position, a known Wi-Fi signal, or common household objects detected in images captured by the camera. The mobile device may then recommend a common household item (such as, for example, a notebook, kitchen counter, or a coffee table) to use as a background for better image contrast. In an embodiment where the object is a government identification, the recommendation may also prompt the user to use a different identification while at home. For example, the mobile device may recommend using a passport rather than a driver's license.

In an embodiment, a motion sensor of the mobile device may detect that the camera is unstable and will not capture a high quality image. For example, the user may attempt to capture an image on a bus or a subway. A wireless connection that is inconsistent may provide separate data indicating that a user is riding a subway. Further, audio captured via a microphone on the mobile device might also provide redundant data confirming the location. In response to this detection, the mobile device may generate a recommendation indicating that the user should wait until arriving at the desired location. In an embodiment, the mobile device may attempt to perform image stabilization or correction. This may occur if accelerometer data indicates that the mobile device is vibrating. This vibration may occur due to movement within a vehicle and/or movement by the user.

In an embodiment, the mobile device may be configured to detect an agitation state related to a user. The agitation state may be a pattern of behavior indicating that a user has become or is becoming frustrated with the image capture process. Various sensors on the mobile device may aid in detecting this pattern. For example, a voice sensor may detect an increase in speech volume and/or may identify particular keywords representing a user's frustration. Similarly, a motion sensor may detect whether the user is shaking the mobile device. A front facing camera may also capture the user's facial expression. The mobile device may perform image classification to identify a particular emotion related to the user. The mobile device may use this information in a machine learning context to determine whether the user is in an agitation state. A neural network may be trained to identify these patterns and to determine whether an agitation state has been detected.

In response to identifying an agitation state, the mobile device may play an audio file or generate a GUI display having text. The audio and/or text may include keywords related to encouragement and/or may attempt to soothe the user. For example, the audio file played may say “You're doing great! We've almost got it.”

In an embodiment, the mobile device may identify questions asked by the user. In response to identifying an agitation state, the mobile device may play an audio file providing an answer to the question asked. In an embodiment, if the mobile device detects that the quality of the image decreases, the mobile device may recommend returning to a previous camera and/or object position in an attempt to obtain a higher quality image. This recommendation may occur in response to detecting glare or shadows.

In view of the described embodiments and as will be further described below, the disclosed generation of a recommendation displayed on a GUI for positioning a camera and/or object based on environment information may allow for more efficient image capture. In particular, fewer processing steps are wasted attempting to capture images of poor quality. For example, less computer processing may be needed to capture data in the images, thus computing resources such as processing and memory may be used more effectively. The feedback provided to a user may be directly correlated with the surrounding environment of the mobile device through a machine learning or decision tree configuration. These configurations may allow for a fast generation of a recommendation based on multiple sources of data related to the mobile device. In this manner, the described embodiments result in a faster recommendation process as well as a faster image capture process.

Various embodiments of these features will now be discussed with respect to the corresponding figures.

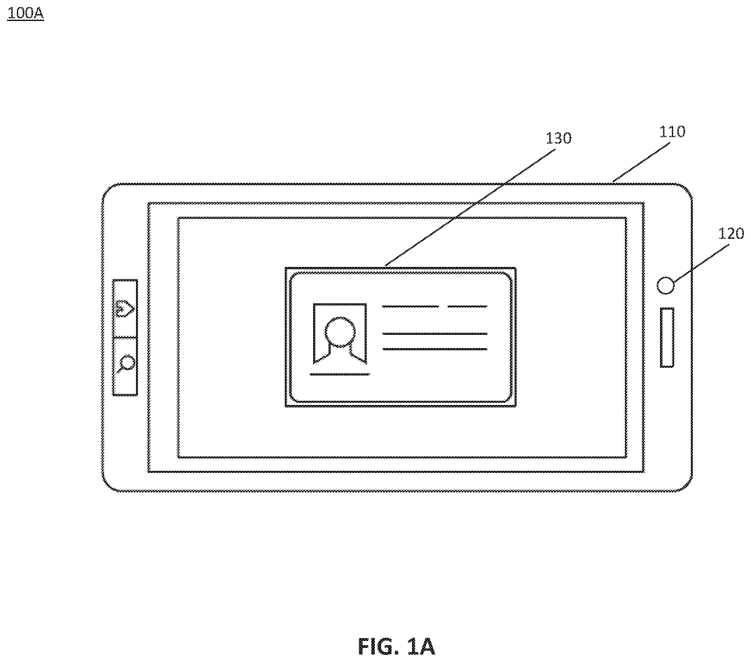

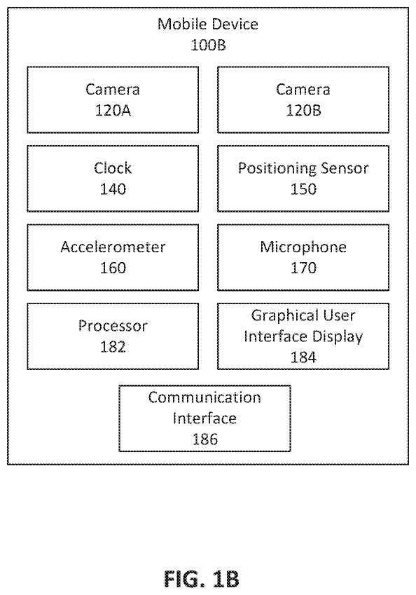

FIG. 1A depicts a block diagram of a mobile device 100A, according to some embodiments. Mobile device 100A may include a casing 110, a camera 120, and/or an image preview 130. Mobile device 100A may be a smartphone, tablet, wearable computer, smart watch, augmented reality (AR) glasses, a laptop, and/or other mobile computing device having a camera 120. Using mobile device 100A, a user may capture an image of an object. The object may include a document or card. In an embodiment, the object may be a government identification.

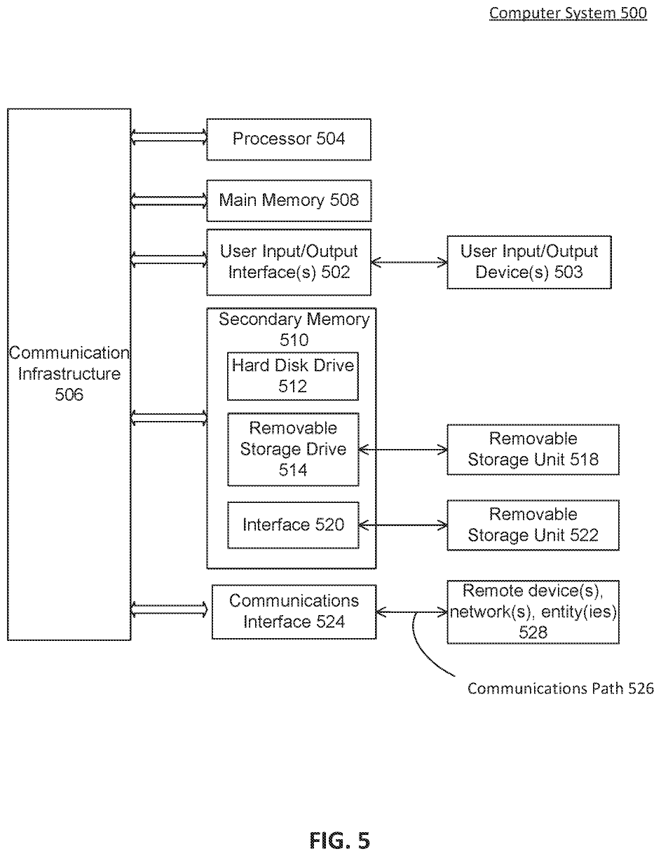

The casing 110 may contain various sensors of the mobile device 100A. These sensors will be further described with reference to FIG. 1B. Mobile device 100A may include one or more cameras 120 to aid in capturing the image. Mobile device 100A may also include one or more processors and/or may include hardware and/or software that may be configured to capture images of an object. In an embodiment, mobile device 100A may be implemented using computer system 500 as further described with reference to FIG. 5.

Mobile device 100A may include a graphical user interface (GUI) display screen configured to display image preview 130. Image preview 130 may display the content currently captured by a camera 120. For example, a user may position mobile device 100A such that camera 120 is pointing toward an identification card. Image preview 130 may then display the identification card via the image captured by camera 120. Image preview 130 may allow a user to preview the image before deciding to capture the image. To capture the image, the user may interact with the GUI display screen. For example, the user may tap a button or an icon.

In an embodiment, image preview 130 and the accessing of camera 120 may occur within an application. The application may include software configured to validate an image of an identification document. For example, the user may access the application and the application may access camera 120 to allow the user to capture an image of the identification document. The application may generate image preview 130 to aid in the image capture process.

The image preview 130 may also include visual elements aiding a user. For example the image preview 130 may include an overlay or augmented reality (AR) display, such as displaying a rectangular box to allow a user to position camera 120 and/or the object intended to be photographed. The image preview 130 may suggest that the identification document be positioned within the rectangular box. In this manner, image preview 130 and the underlying application may aid a user in capturing a high quality image. If the object is an identification document, a high quality image may include text that is visible and/or readable. The high quality image may also include an image of a user or a person that is also visible. The image may not include glare or shadows obscuring information from the identification document.

In an embodiment, a user may experience difficulty capturing a high quality image. For example, when capturing an image of an identification document, parts of the image may be obscured. The user may also experience difficulty if mobile device 100A is vibrating and reducing image stability. Further, the user may experience difficulty if the angle of the camera 120 relative to the object is not aligned.

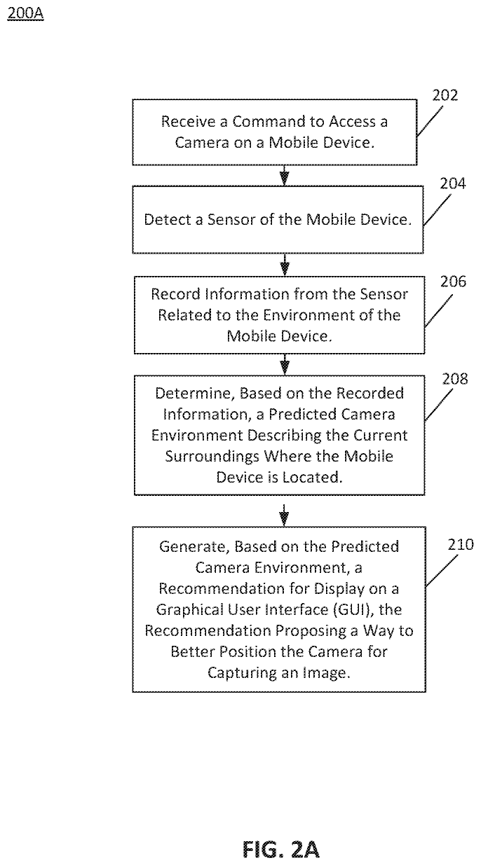

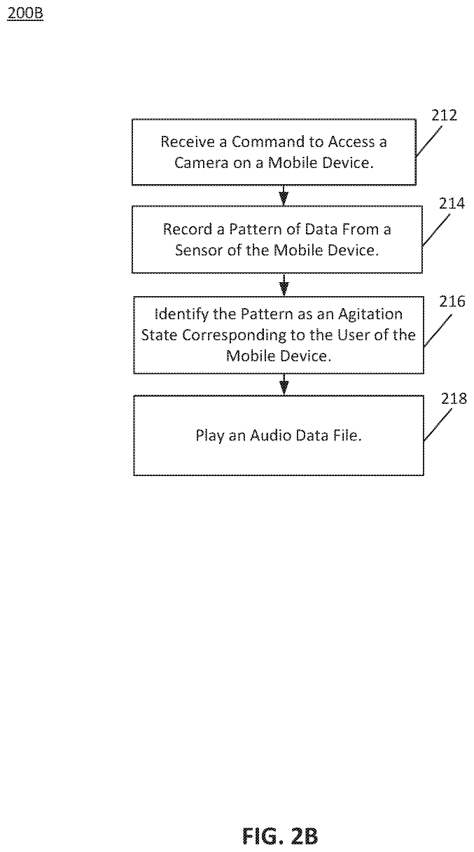

If a user experiences difficulty capturing the image, the mobile device 100A and/or an application operating on mobile device 100A may record information from camera 120 and/or from another sensor from mobile device. The information may be related to the environment surrounding mobile device 100A. Using this environmental information, mobile device 100A and/or an application operating on mobile device 100A may generate a recommendation for positioning the camera and/or object to aid capturing the image. This process will be further discussed with reference to FIG. 2A.

FIG. 1B depicts a block diagram of components of a mobile device 100B, according to some embodiments. Mobile device 100B may operate in a manner similar to mobile device 100A as described with reference to FIG. 1A. Mobile device 100B may include different components including sensors, a processor 182, a graphical user interface (GUI) display 184, and/or a communication interface 186. These components may aid in collecting information and/or data related to the environment surrounding a mobile device and generating a recommendation based on the surrounding environment.

For example, mobile device 100B may include a camera 120A and/or 120B. Camera 120A may be a rear-facing camera while camera 120B may be a front-facing camera. Either camera 120 may capture image data useful for generating a predicted camera environment. Mobile device 100B and/or an underlying application may apply image classification techniques to aid in identifying the surrounding environment. For example, the image classification techniques may identify objects in the background of images. These image classification techniques may include applying pre-processing such as converting images into greyscale or RGB values and/or applying a convolutional neural network including applying a convolutional layer, a ReLU layer, a pooling layer, and/or fully connected layer. In an embodiment, the camera 120 may sense ambient light and/or aid in determining a time of day. Mobile device 100B may operate one or both cameras 120 to record this information. As will further be explained, a front-facing camera 120B may also be used in determining an agitation state.

Mobile device 100B may include a clock 140. Clock 140 may include timestamps that may be used to determine the time of day. Clock 140 may be changeable based on time zones and may be used to provide particular environmental information depending on the time in a particular geographic area. For example, the time from clock 140 may be analyzed with data collected from another application, such as a weather application, to identify the particular weather conditions occurring at that time. This weather information may influence the available light for a mobile device 100B to capture an image.

Positioning sensor 150 may also aid in determining the environment surrounding the mobile device 100B. Positioning sensor 150 may include a sensor providing a geographic reference location such as a Global Positioning System (GPS) location. This positioning information may allow mobile device 100B and/or an underlying application to identify the location of the mobile device 100B and further generate a recommendation based on the location. For example, the location information may allow mobile device 100B to identify that the user is indoors, outdoors, traveling in a vehicle, and/or other locations. In an embodiment, location information may be recorded over time to track a pattern of movement. The positioning sensor 150 may also include an altimeter.

The movement of mobile device 100B may also be identified using accelerometer 160. Accelerometer 160 may provide information related to a positioning of a camera 120 and/or mobile device 100B. For example, accelerometer 160 may identify a particular tilt of a camera 120. As will be further described below, accelerometer 160 may also aid in identifying an agitation state based on patterns of information recorded from accelerometer 160 such as shaking.

Mobile device 110 may also include microphone 170. Microphone 170 may record audio information related to the environment surrounding mobile device 100B. For example, microphone 170 may identify sounds such as radio sounds that may indicate that the mobile device 100B is located in a car. Microphone 170 may also record sounds of a subway to identify that the mobile device 100B is located in a subway. As will be further described below, microphone 170 may also aid in identifying an agitation state based on patterns of information recorded from microphone 170 such as a loud voice or negative keywords.

Mobile device 100B may also include a communication interface 186. Communication interface 186 may allow mobile device 100B to connect to wireless networks such as Wi-Fi or a broadband cellular network. While allowing for this connectivity, communication interface 186 may also provide information related to the environment of mobile device 100B. For example, if mobile device 100B connects to an identified home Wi-Fi network, mobile device 100B may identify the surrounding environment as the user's home. Similarly, if a connection exhibits a pattern of connecting and disconnecting to a broadband cellular network, mobile device 100B may identify that the user is underground or on a subway.

Using the information gathered, processor 182 may identify a predicted camera environment. Processor 182 may implement a machine learning algorithm, a neural network, and/or a decision tree to process the information gathered from the sensors. In an embodiment, processor 182 may communicate with a server external to mobile device 100B, and the server may perform the processing to generate a recommendation. In either case, the environmental data collected may be analyzed to determine a predicted camera environment describing the surroundings of the camera. In an embodiment, the predicted camera environment may be included on a list of possible camera environments. Processor 182 and/or the server may determine this most likely possible camera environment from the list using a ranking system depending on the gathered information. In an embodiment, a neural network may be trained to process the received information. In an embodiment, other machine learning techniques may also be used such as a support vector machine (SVM), a regression analysis, a clustering analysis, and/or other machine learning techniques.

Based on the predicted camera environment, processor 182 and/or a remote server may determine a recommendation. The recommendation may include instructions to be displayed on GUI display 184. The recommendation may suggest a camera location and/or an object location and may include text and/or images. In an embodiment, the recommendation may correspond to the predicted camera environment. Different predicted camera environments may be mapped to different recommendations. For example, if the predicted camera environment is a car, the recommendation may be to place the object on the dashboard to capture the image. A mapping of predicted camera environments to recommendations may be built using a decision tree and/or using machine learning. As previously described, the machine learning techniques may include using a trained neural network, SVM, a regression analysis, a clustering analysis, and/or other machine learning techniques.

Upon determining a recommendation based on the predicted camera environment, mobile device 100B may display the recommendation on GUI display 184. A user is then able to visualize the feedback and adjust the camera position and/or the object position accordingly. In this manner, mobile device 100B and/or an underlying application may provide real-time feedback to a user attempting to capture an image. Further, this feedback corresponds to the environment where the mobile device 100B is located.

FIG. 2A depicts a flowchart illustrating a method 200A for generating a recommendation on a graphical user interface (GUI) for positioning a camera, according to some embodiments. Method 200A shall be described with reference to FIG. 1B; however, method 200A is not limited to that example embodiment.

In an embodiment, mobile device 100B may utilize method 200A to generate a recommendation for positioning a camera based on environmental information. While method 200A is described with reference to mobile device 100B, method 200A may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof

It is to be appreciated that not all steps may be needed to perform the disclosure provided herein. Further, some of the steps may be performed simultaneously, or in a different order than shown in FIG. 2A, as will be understood by a person of ordinary skill in the art.

At 202, mobile device 100B may receive a command to access a camera 120. For example, a user may navigate to an application and/or provide permission to the application to access the camera 120. The user may select an application icon from GUI display 184. This application may be connected to a remote server such that images captured at mobile device 100B may be transmitted to the remote server. In an embodiment, the remote server may be configured to receive images of identification documents, such as a driver's license or a passport. The remote server may verify identity information using the images captured at mobile device 100B.

At 204, mobile device 100B may detect a sensor. The sensor may be internal to mobile device 100B. In an embodiment, one or more detected sensors may be identified corresponding to the sensors available in mobile device 100B. For example, a mobile device 100B may not include a positioning sensor 150. In this case, an application managing the camera access may identify that positioning sensor 150 will be unavailable when determining the environment of the mobile device. In this manner, at 204, the mobile device 100B and/or the underlying application may identify the available sensors of the mobile device 100B. Using this available sensor information, the mobile device 100B and/or the underlying application may record information related to environment of the mobile device 100B.

In an embodiment, at 206, mobile device 100B may record information from the sensor. The recorded information may relate to the environment of the mobile device. In an embodiment, if several sensors are available, mobile device 100B may record data from each of the available sensors.

In an embodiment, mobile device 100B may select a subset of the sensors to receive information. The sensors may be selected based on a preset configuration and/or a hierarchical nature. For example, some information may be deemed to provide better environmental context, such as positioning sensor 150 or camera 120. The availability to record information from these sensors may influence the selection of other sensors. In an embodiment, the recorded information may also cause a subsequent sensor to record information. For example, if communication interface 186 detects that mobile device 100B has connected to a public Wi-Fi network, a camera 120 may be activated to determine whether the user is located indoors or outdoors.

At 208, mobile device 100B may determine, based on the recorded information, a predicted camera environment describing the current surroundings where the mobile device is located. In some embodiments, mobile device 100B may record information from sensors other than camera 120. For example, the predicted camera environment may be determined before obtaining access to the camera 120. In this manner the data recorded may not include information captured from camera 120.

In some embodiments, image data captured from camera 120 may be used with other recorded sensor data to determine the predicted camera environment. For example, the image data may be images captured during previous validation attempts and/or may be image data captured for the purpose of predicting the camera environment. In an embodiment, the images data may be captured automatically. These types of image data may be considered test image data. For example, mobile device 100B may apply image classification, object detection, and/or object classification to the test image data captured from a camera 120 to aid in determining the predicted camera environment. Image classification, object detection, and/or object classification may use machine learning techniques such as linear regression models, non-linear models, multilayer perceptron (MLP), convolutional neural networks, recurrent neural networks, a support vector machine (SVM), a regression analysis, a clustering analysis, and/or other machine learning techniques. Mobile device 100B may detect an object in the test image and classify the test image according to the object detected. In an embodiment, the test image data may include peripheral image data around an object that may be used for image classification. For example, if a user is attempting to capture an image of an identification card, peripheral image data may include a steering wheel in the peripheral portions of the image. Using this information, mobile device 100B may identify the predicted camera environment as being within a vehicle.

Regardless of whether mobile device 100B has captured test image data from a camera 120, mobile device 100B may apply machine learning algorithms, a neural network, and/or a decision tree to received image data and/or sensor data to determine the predicted camera environment. The neural network may have been trained using training data correlating received information with a particular predicted camera environment. As previously described, factors included in the training data may include input data such as image data and/or sensor data, and output data indicating the predicted camera environment. Input data may include image or sensor data. Examples of input data may include whether the mobile device has detected a Bluetooth connection, whether a captured image includes a steering wheel, or the time of day. Other input data may include image data, background image data, the type or quality of a wireless communication, audio information, accelerometer data, positioning data such as a GPS location or geographic pattern of movement, data gathered from a website such as the weather, and/or other image data.

The training data may also include output data mapping the input data to the predicted camera environment. For example, the output data may correlate the input data to whether the mobile device is located indoors or outdoors, whether the mobile device is located in a particular room in a location, whether the mobile device is in a vehicle, whether the vehicle is moving, the type of vehicle, or the location where the user has placed the object. The training data may map one or more groups of factors to a particular predicted camera environment. For example, the neural network may use a scoring or ranking system based on the detected patterns of data received from the sensors. After training, mobile device 100B may apply the neural network at 208 to determine a predicted camera environment based on the information recorded at 206.

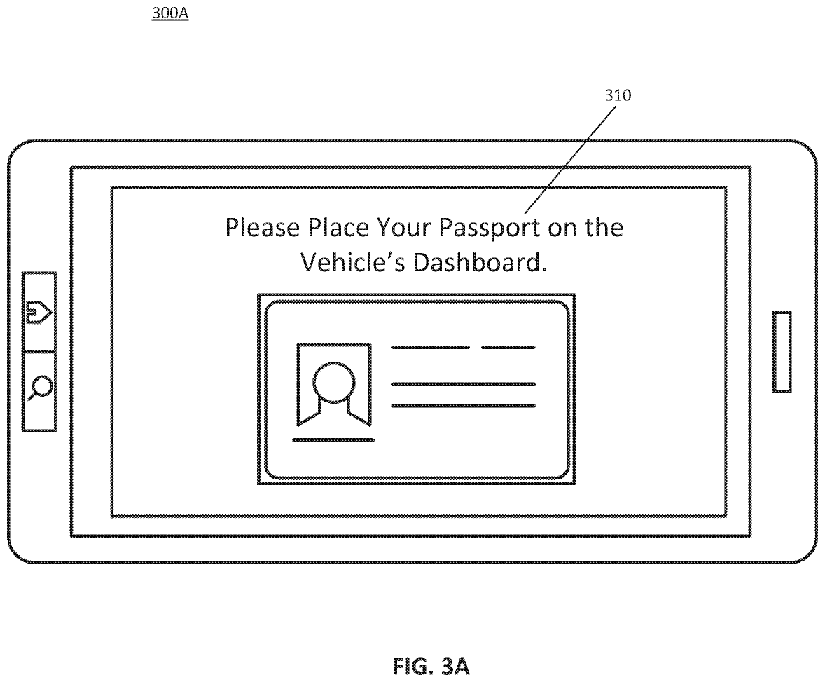

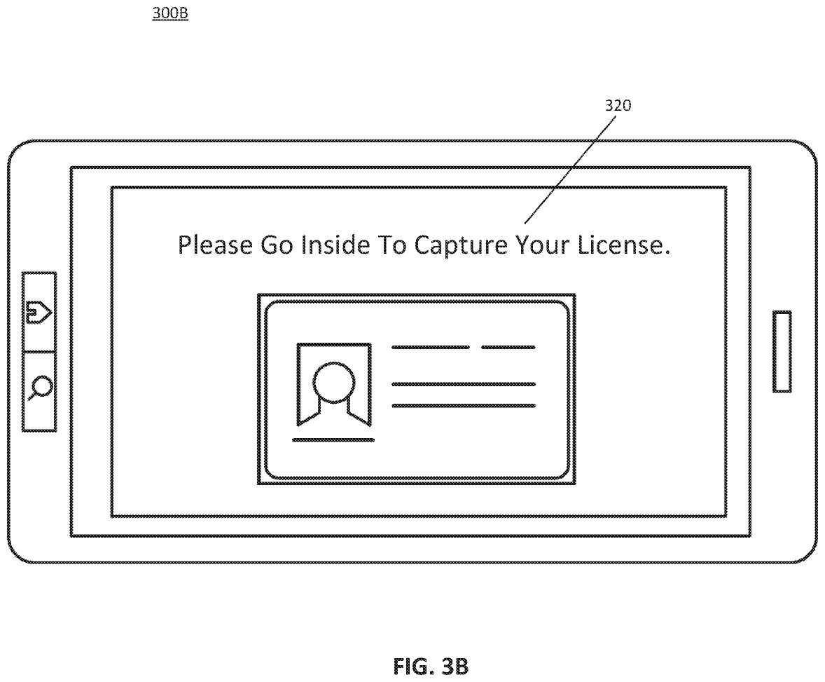

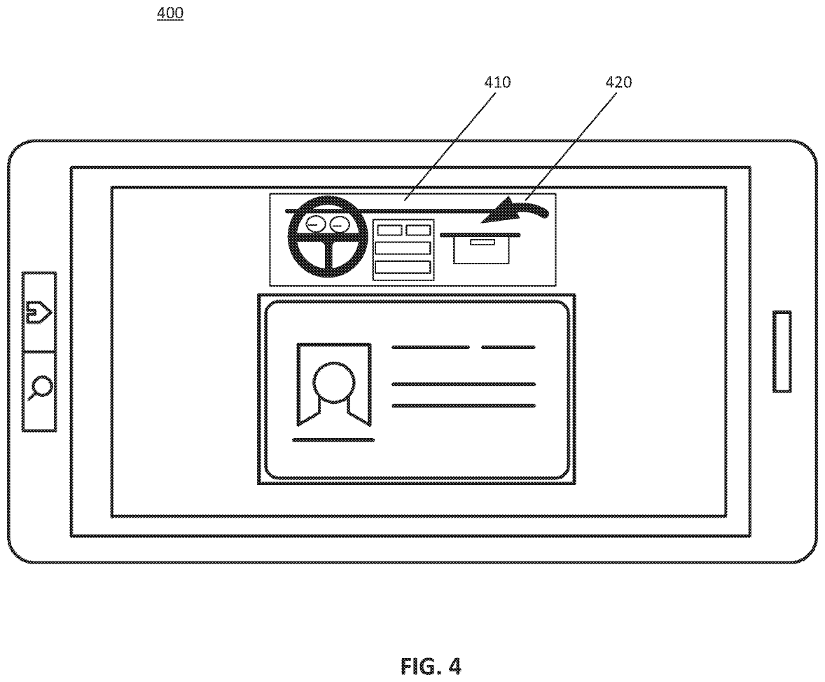

At 210, mobile device 100B may generate, based on the predicted camera environment, a recommendation for display on a GUI. The recommendation may propose a way to better position the camera for capturing an image. The recommendation may be correlated and/or mapped to the predicted camera environment. The machine learning, neural network, and/or decision tree techniques described with reference to 208 may also generate the recommendation. The recommendation may be a textual message, image, icon, video, and/or animated image displayed on GUI display 184. Example embodiments of this recommendation are further described with reference to FIG. 3A, FIG. 3B, and FIG. 4. This recommendation may aid a user in positioning the camera and/or the object to aid in capturing a higher quality image.

FIG. 2B depicts a flowchart illustrating a method 200B for identifying an agitation state, according to some embodiments. Method 200B shall be described with reference to FIG. 1B; however, method 200B is not limited to that example embodiment.

In an embodiment, mobile device 100B may utilize method 200B to identify an agitation state. While method 200B is described with reference to mobile device 100B, method 200B may be executed on any computing device, such as, for example, the computer system described with reference to FIG. 5 and/or processing logic that may comprise hardware (e.g., circuitry, dedicated logic, programmable logic, microcode, etc.), software (e.g., instructions executing on a processing device), or a combination thereof

It is to be appreciated that not all steps may be needed to perform the disclosure provided herein. Further, some of the steps may be performed simultaneously, or in a different order than shown in FIG. 2B, as will be understood by a person of ordinary skill in the art.

At 212, mobile device 100B may receive a command to access a camera 120. For example, a user may navigate to an application and/or provide permission to the application to access the camera 120. The user may select an application icon from GUI display 184. This application may be connected to a remote server such that images captured at mobile device 100B may be transmitted to the remote server. In an embodiment, the remote server may be configured to receive images of identification documents, such as a driver's license or a passport. The remote server may verify identity information using the images captured at mobile device 100B.

At 214, mobile device 100B may record a pattern of data from a sensor of the mobile device. At 216, mobile device 100B may identify the pattern as an agitation state corresponding to the user of the mobile device. The pattern recorded may be identified while a user is attempting to capture an image. These patterns may be pre-programmed and/or detected using a machine learning process trained to identify agitation patterns. For example, the machine learning process may include linear regression models, non-linear models, multilayer perceptron (MLP), convolutional neural networks, recurrent neural networks, a support vector machine (SVM), a regression analysis, a clustering analysis, and/or other machine learning techniques.

The agitation state may be a pattern of behavior indicating that a user has become or is becoming frustrated with the image capture process. Various sensors on the mobile device 100B may aid in detecting this pattern. For example, microphone 170 may detect an increase in speech volume and/or may identify particular keywords representing a user's frustration. Similarly, accelerometer 160 may detect whether the user is shaking the mobile device. A front facing camera 120B may also capture the user's facial expression or facial features. The mobile device 100B may perform image classification to identify a particular emotion related to the user. The mobile device 100B may use this information in a machine learning context to determine whether the user is in an agitation state. A neural network may be trained to identify these patterns and to determine whether an agitation state has been detected.

At 218, in response to detecting an agitation state, mobile device 100B may play an audio data file. In an embodiment, mobile device 100B may also generate a textual message. The audio and/or text may include keywords related to encouragement and/or may attempt to soothe the user. For example, the audio file played may say “You're doing great! We've almost got it.”

In an embodiment, mobile device 100B may identify questions asked by the user via microphone 170. In response to identifying an agitation state, mobile device 100B may play an audio file providing an answer to the question asked. In an embodiment, if mobile device 100B detects that the quality of the image decreases, mobile device 100B may recommend returning to a previous camera and/or object position in an attempt to obtain a higher quality image. This recommendation may occur in response to detecting glare or shadows.

In an embodiment, method 200A, method 200B, and/or portions of method 200A and/or method 200B may be initiated in response to different scenarios. For example, when an application is accessed on mobile device 100B, mobile device 100B may initialize the methods 200A, 200B in a standby state to be performed in response to detecting different sensor data. For example, sensor and/or image data may be recorded automatically in response to accessing the application. A predicted camera environment and/or an agitation state may be determined based on the sensor and/or image data. In an embodiment, portions of methods 200A, 200B may be triggered when the application has detected one or more low quality images being captured. For example, the detection of one or more low quality images may trigger the initialization of monitoring sensor and/or camera data. In an embodiment, an elapsed time may be the triggered. Similarly, different sensors may be accessed or initialized depending on the particular problem associated with the image capture. For example, if mobile device 100B detects that the image quality is poor, mobile device 100B may access a separate sensor and/or sensor data to determine positional information. Similarly, mobile device 100B may trigger object recognition to determine a suggested surface.

FIG. 3A depicts a block diagram of GUI 300A displaying a textual recommendation 310 related to the object for image capture, according to some embodiments. For example, textual recommendation 310 may state “Please Place Your Passport on the Vehicle's Dashboard.” This textual recommendation 310 may have been determined based on the environmental information detected indicating that the user is attempting to capture an image while in a vehicle and/or determining that a surface identified in a test image did not provide sufficient contrast, for example. A different recommendation may be determined based on other environmental information detected indicating that the user is indoors, outdoors, and/or in another predicted camera environment. The textual recommendation 310 may be an overlay over an image preview of the camera view of the device. In this manner, the user may view both the object and the textual recommendation 310 simultaneously. In an embodiment, the textual recommendation 310 may appear as characters near the object in an augmented reality view.

FIG. 3B depicts a block diagram of GUI 300B displaying a textual recommendation 320 related to the camera position for image capture, according to some embodiments. For example, textual recommendation 320 may state “Please Go Inside to Capture Your License.” This textual recommendation 320 may have been determined based on the environmental information detected indicating that the user is attempting to capture an image while outside. In the daytime, the mobile device may have detected excessive sunlight or glare. In the night time, the mobile device may have detected excessive shadows or darkness. The textual recommendation 320 may be an overlay over an image preview of the camera view of the device. In this manner, the user may view both the object and the textual recommendation 320 simultaneously. In an embodiment, the textual recommendation 320 may appear as characters near the object in an augmented reality view.

FIG. 4 depicts a block diagram of GUI 400 displaying an image recommendation 410, according to some embodiments. For example, image recommendation 410 may depict a vehicle's dashboard. This image recommendation 410 may have been determined based on the environmental information detected indicating that the user is attempting to capture an image while in a vehicle. The image recommendation 410 may be an overlay over an image preview of the camera view of the device. In this manner, the user may view both the object and the image recommendation 410 simultaneously. In an embodiment, the image recommendation 410 may appear as an image near the object in an augmented reality view.

Image recommendation 410 may include an animation 420. Animation 420 may be a portion of image recommendation 410 and/or may be the image recommendation 410 itself. For example, animation 420 may be a video or a Graphics Interchange Format (GIF) image. In an embodiment, the image recommendation 410 may be a vehicle's dashboard while the animation 420 may be an arrow moving and pointing to a flat surface on the dashboard. In an embodiment, another image recommendation 410 or animation 420 may include depicting a license being placed on a notebook or coffee table if the environmental information indicates that the mobile device is located inside or at the user's home. While the image recommendation 410 and/or animation 420 may indicate a position to place an object, image recommendation 410 and/or animation 420 may also indicate a position to place the camera for capturing the image. For example, image recommendation 410 and/or animation 420 may indicate that the camera should be tilted relative to the object.

FIG. 5 depicts an example computer system useful for implementing various embodiments.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method, comprising:
receiving a command to access a camera on a mobile device;
in response to the receiving, selecting a sensor, from a plurality of sensors of the mobile device, wherein the selecting is based on a preset configuration configured to determine which sensor from the plurality of sensors provides better environmental context for the mobile device;
recording information from the sensor related to an environment of the mobile device;
capturing a first image via the camera, wherein the first image captures an identification document and an object peripheral to the identification document;
identifying the object peripheral to the identification document as captured in the first image by classifying the first image;
determining, based on the recorded information and the identified object of the first image, a predicted camera environment describing the environment where the mobile device is located; and
generating, based on the predicted camera environment, a recommendation for display on a graphical user interface (GUI), the recommendation proposing a way to better position the camera for capturing a second image of the identification document.

2. The computer-implemented method of claim 1, classifying further comprises:
applying a machine learning algorithm to the first image to classify the first image.

3. The computer-implemented method of claim 2, wherein the machine learning algorithm includes a regression model.

4. The computer-implemented method of claim 2, wherein the applying further comprises:
applying a neural network trained to identify an identification card and peripheral image data around the identification card.

5. The computer-implemented method of claim 1, wherein the recommendation includes an animated image indicating a position to place the camera for capturing the second image.

6. The computer-implemented method of claim 1, further comprising:
recording a pattern of data from a second sensor;
identifying the pattern of data as an agitation state identified by a neural network; and
in response to identifying the pattern as an agitation state, playing an audio data file.

7. The computer-implemented method of claim 6, wherein the identifying further comprises:
recording an image from a second camera of the mobile device; and
identifying, by the neural network, a facial feature from the image from the second camera to identify the agitation state.

8. A system, comprising:
a memory device; and
at least one processor coupled to the memory device and configured to:
receive a command to access a camera on a mobile device;
in response to the receiving, select a sensor, from a plurality of sensors of the mobile device, wherein the selecting is based on a preset configuration configured to determine which sensor from the plurality of sensors provides better environmental context for the mobile device;
record information from the sensor related to an environment of the mobile device;
capture a first image via the camera, wherein the first image captures an identification document and an object peripheral to the identification document;
identify the object peripheral to the identification document as captured in the first image by classifying the first image;
determine, based on the recorded information and the identified object of the first image, a predicted camera environment describing the environment where the mobile device is located; and
generate, based on the predicted camera environment, a recommendation for display on a graphical user interface (GUI), the recommendation proposing a way to better position the identification document for capturing a second image of the identification document.

9. The system of claim 8, wherein to classify the first image, the at least one processor is further configured to:
apply a machine learning algorithm to the first image to classify the first image.

10. The system of claim 9, wherein the machine learning algorithm includes a regression model.

11. The system of claim 9, wherein to apply the machine learning algorithm, the at least one processor is further configured to:
apply a neural network trained to identify an identification card and peripheral image data around the identification card.

12. The system of claim 8, wherein the recommendation includes an animated image indicating a position to place the camera for capturing the second image.

13. The system of claim 8, wherein the at least one processor is further configured to:
record a pattern of data from a second sensor;
identify the pattern of data as an agitation state identified by a neural network; and
in response to identifying the pattern as an agitation state, play an audio data file.

14. The system of claim 13, wherein to identify the pattern of data as an agitation state, the at least one processor is further configured to:
record an image from a second camera of the mobile device; and
identify, by the neural network, a facial feature from the image from the second camera to identify the agitation state.

15. A non-transitory computer-readable device having instructions stored thereon that, when executed by at least one computing device, cause the at least one computing device to perform operations comprising:
receiving a command to access a camera on a mobile device;
in response to the receiving, selecting a sensor, from a plurality of sensors of the mobile device, wherein the selecting is based on a preset configuration configured to determine which sensor from the plurality of sensors provides better environmental context for the mobile device;
recording information from the sensor related to an environment of the mobile device;
recording test image data from the camera related to the environment of the mobile device, wherein the test image data captures an identification document and an object peripheral to the identification document;
identifying the object peripheral to the identification document as recorded in the test image data;
determining, based on the recorded information and the identified object of the first image, a predicted camera environment describing the environment where the mobile device is located; and
generating, based on the predicted camera environment, a recommendation for display on a graphical user interface (GUI), the recommendation proposing a way to better position the camera for capturing a second image of the identification document.

16. The non-transitory computer-readable device of claim 15, wherein to classify the test image data, the operations further comprise:
applying a machine learning algorithm to the test image data to classify the test image data.

17. The non-transitory computer-readable device of claim 16, wherein the machine learning algorithm includes a regression model.

18. The non-transitory computer-readable device of claim 16, wherein to apply the machine learning algorithm, the operations further comprise:
applying a neural network trained to identify an identification card and peripheral image data around the identification card.

19. The non-transitory computer-readable device of claim 15, wherein the recommendation includes an animated image indicating a position to place the camera for capturing the second image.

20. The non-transitory computer-readable device of claim 15, the operations further comprising:
recording a pattern of data from a second sensor;
identifying the pattern of data as an agitation state identified by a neural network; and
in response to identifying the pattern as an agitation state, playing an audio data file.
